(19) United States
(12) Patent Application Publication
(10) Pub. No.: US 2024/0381137 A1
(43) Pub. Date: Nov. 14, 2024

(54) UPLINK COMMUNICATIONS BASED ON RADIO AND FLOW CHARACTERISTICS

(71) Applicant: QUALCOMM Incorporated, San Diego, CA (US)

(72) Inventors: Sitaramanjaneyulu KANAMARLAPUDI, San Diego, CA (US); Arnaud MEYLAN, San Diego, CA (US)

(21) Appl. No.: 18/317,015

(22) Filed: May 12, 2023

(51) Int. Cl. H04W 24/08; H04L 43/026

(52) U.S. Cl. CPC H04W 24/08; H04L 43/026

(57) ABSTRACT

Certain aspects relate to wireless communications between a wireless node and a network entity. In some examples, the wireless node may be configured to obtain, via a first link, a first signal comprising one or more packets, the one or more packets being less than a number of packets the apparatus expects from the first signal. In some examples, the wireless node may be configured to output for transmission, based on the one or more packets being less than the number of packets expected, a second signal via a second link based on one or more communication parameters associated with one or more of a radio metric or a flow-level metric.

### BACKGROUND

### Technical Field

The present disclosure generally relates to communication systems, and more particularly, to uplink communications based on radio and flow characteristics.

### INTRODUCTION

Wireless systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to an apparatus configured for wireless communication. In some examples, the apparatus includes a memory comprising instructions and one or more processors configured to execute the instructions. In some examples, the one or more processors are configured to cause the apparatus to obtain, via a first link, a first signal comprising one or more packets. In some examples, the one or more processors are configured to cause the apparatus to output, if a quantity of the one or more packets is less than an expected quantity, a second signal for transmission via a second link, the output being based on one or more communication parameters associated with one or more of a radio metric and a flow-level metric.

Certain aspects are directed to a method for wireless communication an apparatus. In some examples, the method includes obtaining, via a first link, a first signal comprising one or more packets. In some examples, the method includes outputting, if a quantity of the one or more packets is less than an expected quantity, a second signal for transmission via a second link, the output being based on one or more communication parameters associated with one or more of a radio metric and a flow-level metric.

Certain aspects are directed to an apparatus configured for wireless communication. In some examples, the apparatus includes means for obtaining, via a first link, a first signal comprising one or more packets. In some examples, the apparatus includes means for outputting, if a quantity of the one or more packets is less than an expected quantity, a second signal for transmission via a second link, the output being based on one or more communication parameters associated with one or more of a radio metric and a flow-level metric.

Certain aspects are directed to a non-transitory computer-readable storage medium having instructions stored thereon, that when executed by an apparatus, cause the apparatus to perform operations for wireless communication. In some examples, the operations include obtaining, via a first link, a first signal comprising one or more packets. In some examples, the operations include outputting, if a quantity of the one or more packets is less than an expected quantity, a second signal for transmission via a second link, the output being based on one or more communication parameters associated with one or more of a radio metric and a flow-level metric.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 is a block diagram illustrating example data flows associated with different applications.

FIG. 6 is a call-flow diagram illustrating example communications between a UE and a network entity.

FIG. 7 is a flowchart of a method of wireless communication.

FIG. 8 is a flowchart of a method of wireless communication.

FIG. 9 is a flowchart of a method of wireless communication.

FIG. 10 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

A packet data convergence protocol (PDCP) mechanism for an in-sequence model may operate as follows. A wireless node (e.g., a UE, a base station, or a network entity of the base station) may generate packets (e.g., packet data units) for communication to another wireless node, and each packet may be assigned its own unique sequence number (SN). The wireless node may transmit the packets to the other wireless node such that the packets are in sequence according to their SNs.

5th Generation (5G) new radio (NR) allows the wireless node to transmit the packets without the packets being in sequence. For example, in a 10-packet sequence, the wireless node may generate packets 6-10 but packets 1-5 may be delayed. Because packets 6-10 are transmitted first, the wireless node may start a timer re-ordering (e.g., Treordering). That is, the wireless node may wait a period of time for the delayed packets, wherein that period of time is defined by a re-ordering timer. If packets 1-5 are generated and transmitted to the other wireless node after timer expiration, then the lower edge of the PDCP window becomes 10. In other words, the wireless node may drop packets 1-5 from PDCP out-of-order (OOO).

Thus, PDCP delivery for an in-sequence modem may allow for less than all packets of a transmission control protocol (TCP) window. In such scenarios, an out-of-order delivery (OOOD) delivery protocol may control how communications are performed. In some examples, if the wireless node transmits packets 6-10 to the other wireless node because packets 1-5 are delayed and the timer expired, then the wireless node may wait until packets 1-5 are obtained at the RLC level and then transmit packets 1-5 to the other wireless node. It should be noted that timer may prevent the wireless node from immediately transmitting less than all of packets 1-10 to the other wireless node in order to provide time for the other packets to be obtained at the RLC layer of the wireless node. For example, packets may be delayed due to network-side packet loss, scheduling delays attributable to a particular radio access technology (RAT) and/or a retransmission of the packets, etc. Thus, the timer may provide a window of time for the wireless node to collect the complete sequence of packets 1-10 and account for potential delays.

Accordingly, OOOD may allow a wireless node to deliver packets without waiting for them to be in-order at a PDCP level. OOOD is useful when applications do not require sequential/ordered delivery, when applications can take advantage of the earlier arrival of traffic by buffering, or when applications have redundancy through one or more of a forward error correction (FEC) mechanism, network coding (e.g., Fountain Codes), or other similar aspects. Sometimes applications may also be able to tolerate some packet loss. For example, a video application may tolerate a skipped frame better than a delayed frame, from user experience perspective.

As such, OOOD may allow different data path behavior for communications at the radio bearer (RB) level; however, conventional OOOD may not affect configuration at a flow level (e.g., quality-of-service (QOS) flow level) when multiple flows are mapped to the same RB. For example, there may not be in-sequence and out-of-sequence control at the RB level. In one scenario, the wireless node may receive a first data flow from a WhatsApp™ application and a second data flow from a YouTube™ application simultaneously. The first data flow may have a first QoS flow identifier (QFI) and the second data flow may have a second QFI indicating different QoS characteristics relative to the first QFI. In this example, maintaining an in-sequence flow of the first flow and allowing an out-of-sequence for the second flow is currently not allowed because such actions are taken at the bearer level. As such, when multiple flows are mapped to the same RB, OOOD can only be applied to all or none of the flows at the RB level. This may result in a disappointing user experience when multiple applications are running simultaneously.

For example, if a UE is configured to support PDCP OOOD on a given RB, other flows may be impacted if they are reliability sensitive data flows. In one example, a TCP traffic may be sensitive to a downlink delivery of out-of-sequence packets because it may result in the UE transmitting an uplink duplicate ACK (DUP ACK). Because the DUP ACK is transmitting in the opposite direction of the downlink delivery, throughput may be reduced significantly. Thus, a problem being solved relates to OOOD and reordering timers being configurable at the PDCP RB level but not at the flow level, which may diminish user experience.

Although OOOD and reordering timers being configurable at the PDCP RB level but not at the flow level, QoS parameters (e.g., parameters associated per flow at the flow level) such as packet delay budget (PDB), packet error rate (PER), allocation and retention priority (ARP), maximum bit rate (MBR), guaranteed bit rate (GBR), and any other suitable QoS parameters are configurable at the flow level. Using QoS parameters and traffic characteristics of the flow level, PDCP OOOD may be used more dynamically to effect flow level traffic and adapt to different radio conditions.

For example, the UE may receive packets 6-10 in a downlink, but the UE is expecting packets 1-10. Thus, the UE may determine that packets 1-5 are missing and that it needs to transmit a message in the uplink direction to request the missing packets. Here, the UE can determine how to quickly send the UL based on one or more radio characteristics and/or flow characteristics. That is, the UE may prioritize the UL transmission based on flow level QoS parameters (e.g., flow characteristics) and/or radio characteristics.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

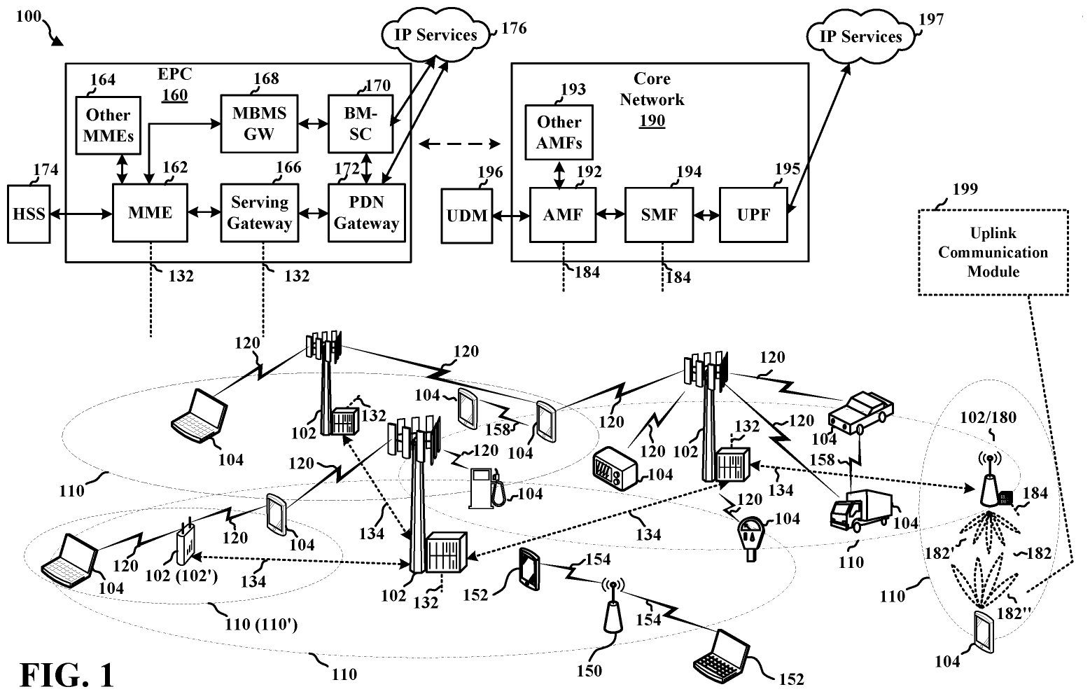

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). The frequencies between FR1 and FR2 are often referred to as mid-band frequencies. Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity of the base station.

Referring again to FIG. 1, in certain aspects, the UE 104 may include an uplink communication module 199 configured to obtain, via a first link, a first signal comprising one or more packets; and output, if a quantity of the one or more packets is less than an expected quantity, a second signal for transmission via a second link, the output being based on one or more communication parameters associated with one or more of a radio metric and a flow-level metric.

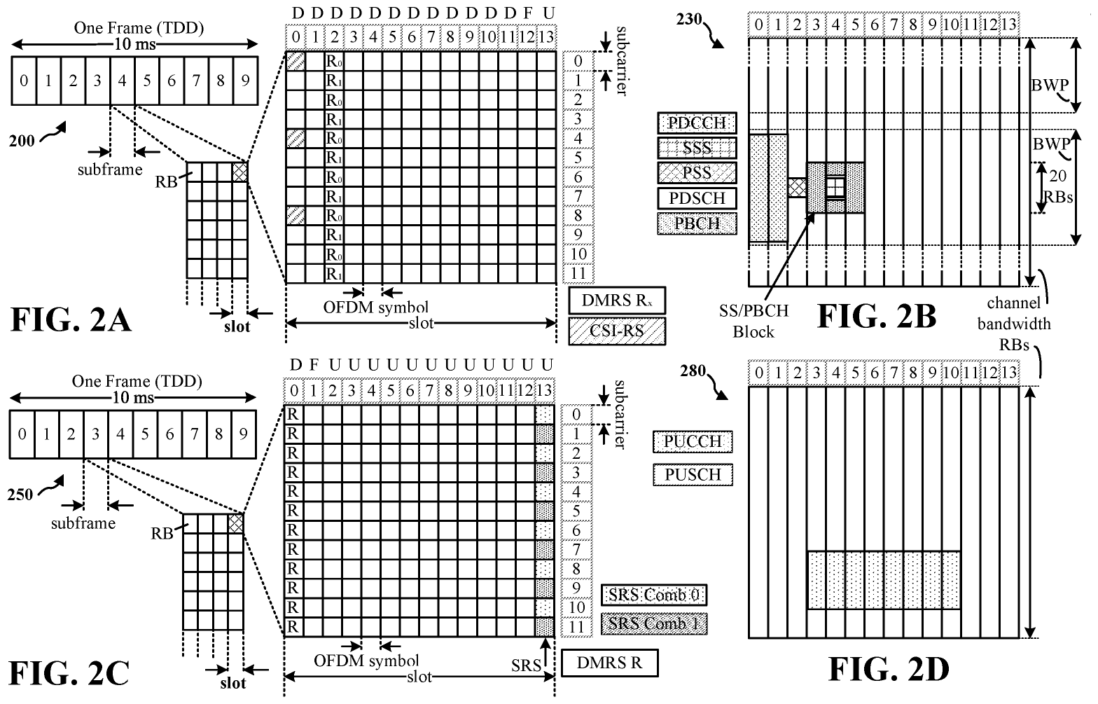

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2^{μ} slots/subframe. The subcarrier spacing and symbol length/duration are a function of the numerology. The subcarrier spacing may be equal to 2^{μ}*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

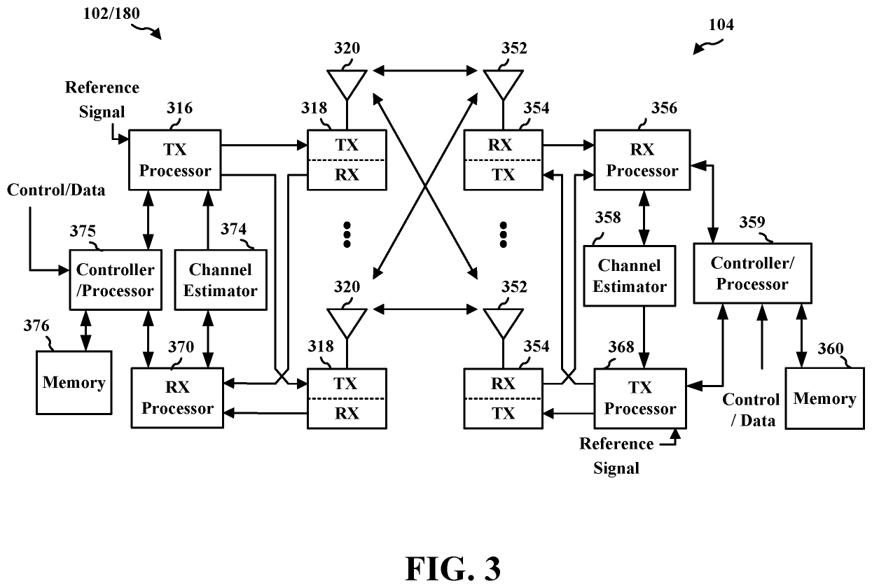

FIG. 3 is a block diagram of a base station 102/180 in communication with a UE 104 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB. SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

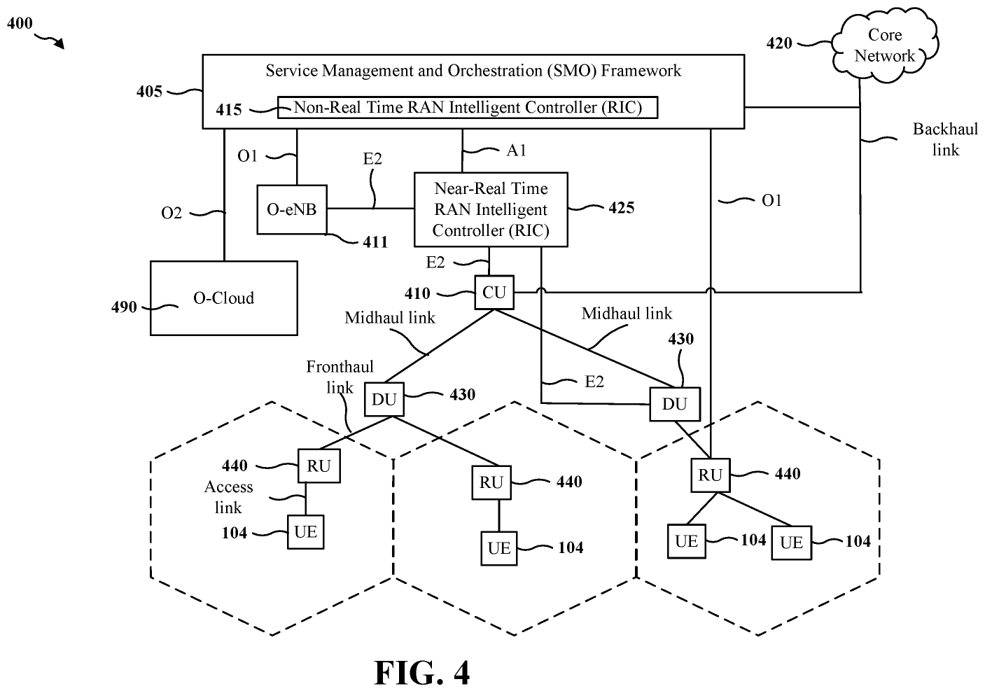

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station. In some examples, the network entity may host an application server, as described here.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-CNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as Al policies).

At least one of the TX processor 368, the RX processor 356, and the controller/processor 359 may be configured to perform aspects in connection with uplink communication module 199 of FIG. 1.

### Examples of Uplink Communications Based on Radio Configuration and/or Flow Characteristics

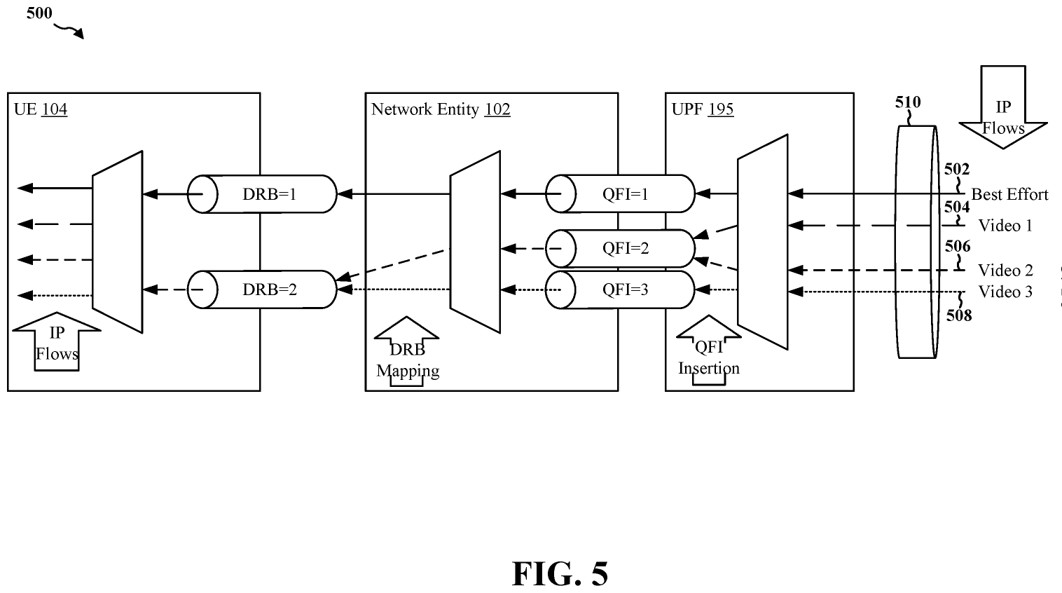

FIG. 5 is a block diagram illustrating example data flows 500 (e.g., internet protocol (IP) flows) associated with different applications. Each flow may be associated with one of multiple protocol data units (PDUs), each of which generates packets of data associated with different QoS requirements. Here, a first flow 502 is labeled a “best effort” flow and may be associated with an application requiring high reliability. A second flow 504 is labeled as “Video 1” and may be associated with a video-communication application (e.g., WhatsApp™). A third flow 506 is labeled as “Video 2” and may also be associated with a video-communication application (e.g., Skype™ Video). A fourth flow 508 is labeled as “Video 3” and may also be associated with a video-communication application. In this example, each application is a PDU session, and each corresponding arrow represents a service data flow associated with each application, where the internet 510 hosts the four PDU sessions.

Multiple data flows may be mapped to a same QoS flow. For example, QoS flow 2 is carries both the second flow 504 and the third flow 506. On the radio interface, each Qos flows is mapped to a data radio bearer (DRB) configured to deliver according to the corresponding QoS requirements. Multiple QoS flows can be mapped to a single DRB. For example, DRB2 may carry QoS flows 2 and 3.

Although the example applications above relate to video-communication applications, it should be noted that other applications may also be used. For example, extended reality (XR) and virtual reality (VR) applications may also use the similar data flows.

As noted above, OOOD may allow different data path behavior for communications at the RB level (e.g., between the UE 104 and the network entity 102); however, conventional OOOD may not affect configuration at a flow level (e.g., quality-of-service (QoS) flow level) when multiple flows are mapped to the same RB. Thus, if a UE is configured to support PDCP OOOD on a given DRB, reliability and latency of other flows may be negatively impacted. For example, if a UE transmits an uplink duplicate ACK (DUP ACK), downlink throughput may be reduced significantly because that DUP ACK is transmitted in the opposite direction of the downlink delivery. Thus, in some examples, the UE 104 may determine to adjust one or more communication parameters associated with the uplink transmission. In certain aspects, the UE may adjust a communication parameter of the uplink transmission based on one or more of a radio metric or a flow-level metric.

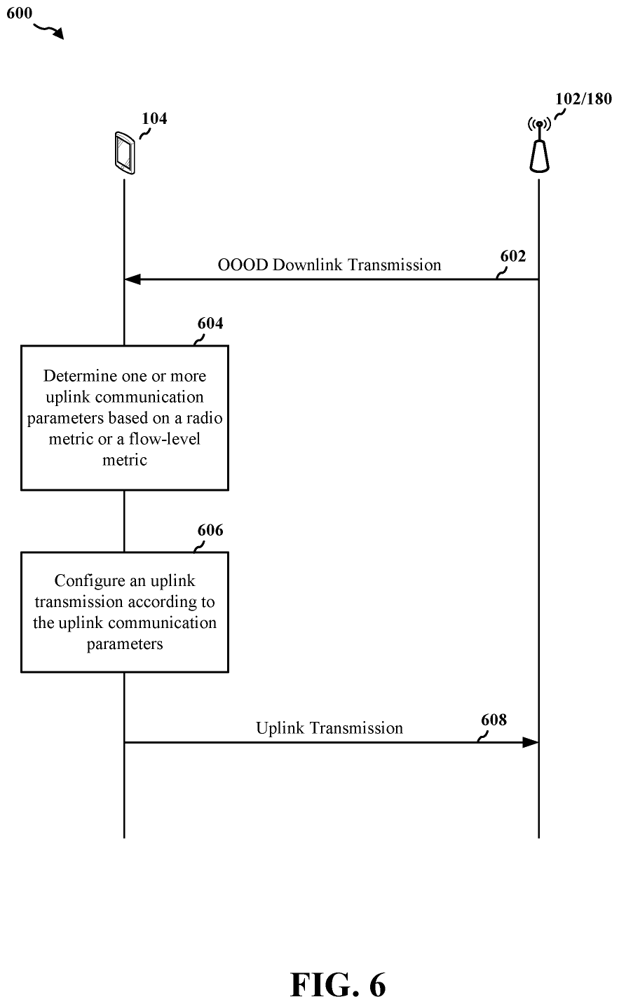

FIG. 6 is a call-flow diagram illustrating example communications 600 between a UE 104 and a network entity 102. In certain aspects, the UE 104 may transmit uplink signaling to the network entity 102 (e.g., if the UE 104 receives less than all packets it expected in a previous downlink transmission, or if the UE 104 transmits periodic XR/VR data against heavy downlink traffic). Here, the UE 104 may determine to adjust how the uplink transmission is made based on radio metrics (e.g., characteristics of the wireless link(s) used for communication between the UE 104 and network entity 102), and/or flow-level metrics (e.g., QoS information).

Initially, the network entity 102 may transmit a first communication 602 to the UE 104. For example, the first communication 602 may be a downlink transmission transmitted via a first link, wherein the downlink transmission includes one or more packets of data for the UE 104. However, the UE 104 may expect the downlink transmission to include additional packets. That is, the downlink transmission may be missing packets as it is received at the UE 104. In some examples, the downlink transmission may be an OOOD. At a first process 604, the UE 104 may determine one or more uplink communication parameters for transmitting an uplink communication to the network entity 102. In some examples, the uplink communication parameters may be based on one or more of a radio metric and/or a flow-level metric (e.g., metrics associated with the QoS flow between the network entity and the UPF 195 illustrated in FIG. 5).

A radio metric may include characteristics of one or more links between the UE 104 and the network entity 102. One radio metric may relate to a TCP application-level recovery speed and/or an access stratus (AS) level recovery speed. For example, such a radio metric may indicate a speed or rate at which TCP level retransmissions are being received by the UE 104 via a downlink transmission. Here, the UE 104 may store the speed or rate of previous retransmissions (e.g., triggered by a DUP ACK transmission from the UE 104) received from the network entity 102. Thus, if the UE 104 transmits a DUP ACK in response to a downlink transmission that does not contain all of the data packets expected by the UE 104, the UE 104 may store the among of time between the DUP ACK transmission and receiving the retransmission with the missing packets. The delay between the DUP ACK transmission and the retransmission may vary according to scheduling rates and/or buffering latencies at the network entity 102. Thus, in this example, a radio metric may include an indication of an amount of time between transmitting a DUP ACK and receiving a retransmission from the network entity 102. In some examples, the radio metric may include an indication of one or more of a scheduling rate and/or a buffering latency associated with the network entity 102. If the retransmission is fast enough to maintain a quality user experience, then the UE 104 may maintain default uplink transmission settings. However, if the retransmission time affects the user experience (e.g., the application server is too slow), then the UE 104 may determine to change the uplink communication parameters associated with transmitting the DUP ACK to compensate for such a delay.

Another example of a radio metric may include cell coverage aspects. For example, one radio metric may relate to a location of the UE 104 relative to the network entity. In certain aspects, the network entity 102 may be a serving cell. Thus, the location of the UE 104 may be indicative of whether the UE 104 is closer to the center of a cell or an edge of the cell. In certain aspects, another radio metric may relate to a signal condition and/or link condition of at least one of the first link (e.g., downlink between UE 104 and network entity 102) and/or the second link (e.g., uplink between UE 104 and network entity 102). For example, the UE 104 may measure a signal to interference and noise ratio (SINR) associated with the first link, and the network entity 102 may measure an SINR associated with the second link and transmit an indication of the measurement to the UE 104. In certain aspects, another radio metric may relate to a data rate of at least one of the first link and/or the second link. For example, the UE 104 may determine an average rate at which the network node 102 transmits downlink data to the UE 104.

Based on any one or more of the radio metrics, the UE 104 may modify or adjust an uplink communication parameter for its transmission of an uplink communication in order to overcome or compensate for scheduling delays and/or pathloss. Alternatively, or in addition, the UE may similarly modify or adjust an uplink communication parameter based on any one or more flow-level metrics.

A flow-level metric may include characteristics the network entity 102 and/or QoS requirements of communications between the UE 104 and network entity 102. One example of a flow-level metric may include a type of error correction capability used by the network entity 102. In some examples, an application server may use error correction where even if a percentage of the downlink packets are lost, the application at the UE 104 may not be affected. However, in some examples, the application server may have no error correction, and may instead depend on lower-layers to deliver packets to the UE in sequence. If the network entity 102 does not utilize an error correction capability, then the UE 104 may determine to modify its uplink communications depending on one or more radio metrics.

Another flow-level metric may be indicative of what type of communication protocol a particular flow or link is using that experiences packet loss. For example, a protocol flow may include a RTP connection, a JPEG/MPEG connection, a UDP connection, and/or a TCP connection.

Another flow-level metric may be indicative of at least one of a QoS requirement of at the first link and/or the second link, a codec degradation of the apparatus as a result of the one or more packets being less than the number of packets the apparatus expects, and/or a type of grant provided to the apparatus via the network node. For example, a flow-level metric may be indicative of a QoS requirement that is not being met for a downlink or uplink communication. Such QoS requirements may include a packet error rate (PER), a PDU-set error rate (PSER), a packet delay budget (PDB), a PDU-set delay budget (PSDB), and any other suitable QoS requirement. In another example, a flow level metric may be indicative of a rate at which the UE 104 is using DUP ACKs to request retransmission of packets. A high rate of DUP ACKs may indicate a high rate of path loss at the downlink. Another flow-level metric may be indicative of whether a codec used by an application executed by the UE 104 has degraded as a result of poor downlink communications (e.g., lost packets and/or scheduling impacts). For example, the flow-level metric may indicate whether a 1080p video has degraded to 720p due to, for example, lost packets. Another flow-level metric may be indicative of the type of uplink grant mechanism is used by the network entity 102. In one example, the network entity 102 may use a dynamic grant or a configured grant that provides the UE 104 with relatively frequent uplink transmission opportunities. In some examples, the network entity 102 may use semi-persistent scheduling (SPS) grants that may provide the UE 104 with fewer opportunities for uplink transmission.

Based on one or more radio metrics and/or flow-level metrics, the UE 104 may determine one or more uplink communication parameters for an uplink transmission at the first process 604. For example, if a particular downlink is affected by OOOD, or one or more radio metrics and/or flow-level metrics reduce the quality of communications between the UE 104 and the network entity 102 then the UE 104 may configure a corresponding uplink transmission such that it is prioritized. In other words, the UE 104 may use the one or more radio metrics and/or flow-level metrics as an input to determining how to transmit an uplink communication. In some examples, the UE 104 may compensate for latency issues caused by downlink OOOD by prioritizing uplink transmissions. By quickly transmitting uplink data and or control information (e.g., uplink control information (UCI)), the UE 104 can cause an application-level retransmission by the network entity 102 faster than if the uplink is not prioritized. Thus, at a second process 606, the UE 104 may configure an uplink transmission according to one or more uplink communication parameters.

In certain aspects, the UE 104 may prioritize a transmission of the corresponding uplink flow over other uplink flows. For example, if the UE's 104 modem is configured with a normal queue and a priority queue, then the UE 104 may use the priority queue for uplink communications that are in response to OOOD downlink flows. In this example, the UE 104 may prioritize the transmission of uplink flows that correspond to OOOD flows in downlink. Thus, in this example, the communication parameter may include a prioritization of an uplink communication determined based on one or more radio metrics and/or flow-level metrics of a communication with the network entity 102.

In certain aspects, the UE 104 may determine to duplicate transmission of uplink communications made in response to OOOD downlink flows. In one example, the UE 104 may transmit the same uplink communication (e.g., same data) via both of two different RLC entities in the case of dual connectivity (DC) (e.g., transmit the uplink communication via FR1 RLC and FR2 RLC, or via LTE RLC and NR RLC). In another example, in the case of carrier aggregation, the UE 104 may transmit the same uplink communication via both of a first component carrier (e.g., CC0) and a second component carrier (e.g., CC1). In this manner, the UE 104 may take an extra step by duplicating uplink transmissions to increase reliability of the uplink communication. In some examples, if he UE 104 transmits uplink communications frequently (e.g., UE sends a lot of uplink data for VR/XR application), the UE 104 may transmit duplicate uplink communications of this data to ensure an application server at the network entity 102 receives the data. Thus, in these examples, the communication parameter may include duplication of an uplink communication based on one or more radio metrics and/or flow-level metrics of a corresponding OOOD downlink communication or a reliability Qos requirement of the uplink communication.

In certain aspects, the UE 104 may select a particular radio resource to use for transmitting an uplink communication made in response to an OOOD downlink flow. Here, the UE 104 may determine that the particular radio resource is an optimal resource based on latency, reliability, MCS, BLER, and/or any other suitable radio resource characteristics. For example, if the UE 104 can transmit an uplink communication via either of an LTE RLC or an NR RLC, but the NR RLC is more reliable and is faster relative to LTE RLC, then the UE 104 may select the NR RLC for transmitting the uplink communication even if resources of the LTE RLC are granted. In another example, the UE 104 may select a particular component carrier (e.g., CC0) of the NR RLC based on CC0 having a lower BLER than another component carrier (e.g., CC1) of the NR RLC. Thus, the communication parameter may include an optimal radio resource selected by the UE 104 in response to a corresponding OOOD downlink communication.

In certain aspects, the UE 104 may be configured with a threshold value (e.g., ul-DataSplitThreshold) indicating a size of data for an uplink data split operation. The threshold value may indicate which RLC (e.g., LTE RLC or NR RLC) to use for uplink transmission based on a size of data being transmitted. For example, if the uplink data is less than 1 k bytes, the threshold value may cause the UE 104 to send the data on LTE only. However, in some examples, the UE 104 may override this threshold value if it determines that another RLC is a faster and/or more reliable RLC for transmitting an uplink communication. Alternatively, the UE 104 may override this threshold to transmit an uplink communication via both RLCs to improve the reliability of the uplink transmission. In another example, the threshold value may be configured to cause the UE 104 to transmit a scheduling request (SR), a buffer status report (BSR), or any other suitable uplink scheduling communication via a particular RLC. In this example, similar to above, the UE 104 may override the threshold value configuration to transmit the uplink scheduling communication via a different RLC or more than one RLCs. Thus, in this example, the communication parameter may include overriding (e.g., in response to a corresponding OOOD downlink communication) a threshold value indicating a size of data for an uplink data split operation.

In certain aspects, the UE 104 may increase the transmit power of an uplink transmission made in response to a corresponding OOOD downlink communication. For example, the UE 104 may transmit an uplink communication with higher power to ensure the network entity 102 reliably receives the uplink communication. Thus, in this example, the communication parameter may include a transmit power for uplink communications, and the transmit power may be adjusted based on a corresponding OOOD downlink communication, and/or any of one or more radio metrics and/or flow-level metrics of a communication with the network entity 102.

In certain aspects, the UE 104 may receive a single DCI configured to provide the UE 104 with a grant for multiple sets of uplink resources (e.g., multiple PUSCH occasions and/or component carriers). In some examples, and in response to OOOD downlink and/or any of one or more radio metrics and/or flow-level metrics, the UE 104 may determine which set of the multiple sets of uplink resources has a higher reliability and/or MCS for uplink transmission. In such an example, the UE 104 may delay an uplink transmission (e.g., if a less reliable set of uplink resources occurs before a more reliable set) to transmit via an optimal set of resources. Thus, the UE 104 may prefer to transmit an uplink communication via a relatively more reliable set of uplink resources over a less reliable set that occurs first in time.

In certain aspects, when OOOD is used on a downlink, the UE 104 will receive packets out of sequence and may generate frequent DUP ACKs. In some cases, the UE 104 may stop generating DUP ACKs when the UE 104 receives the missing packets it expected from a previous downlink. However, if the UE 104 is frequently generating and transmitting DUP ACKs because of OOOD downlink. TCP downlink throughput may be negatively affected. Accordingly, in some examples, the UE 104 may determine to delay an uplink DUP ACK transmission. For example, the UE 104 may receive an OOOD downlink having less than all expected packets. In response, the UE 104 may generate a DUP ACK requesting retransmission of the missing packets, but instead of immediately transmitting the DUP ACK, the UE 104 may delay its transmission for a preconfigured (e.g., the network entity 102 may configure the amount of time that the UE 104 may delay) or defined amount of time. In some examples, the UE 104 may determine the amount of time of the delay based on any of one or more radio metrics and/or flow-level metrics of a communication with the network entity 102. Here, the delay may provide the network entity 102 with enough time to correct the problem and transmit the missing packets to the UE 104 before the UE 104 sends the DUP ACK. Thus, if the missing packets are received by the UE 104 before expiration of the delay, the UE 104 may internally delete the DUP ACK so that it is not transmitted. This avoids signaling a TCP loss to the network entity 102 if such signaling is not necessary. If the missing packets are not received by the time the delay expires, the UE 104 may proceed to transmit the DUP ACK to the network entity 102 to trigger the needed TCP retransmission.

It should be noted that any one or more of the communication parameters discussed above may be modified or otherwise utilized in any combination by the UE 104 for improving its uplink communications. How the UE 104 uses the communication parameters may be based on one or more radio metrics and/or flow-level metrics of communications between the UE 104 and the network entity 102.

Thus, the UE 104 may configure an uplink transmission according to one or more uplink communication parameters based on OOOD downlink and/or one or more radio metrics and/or flow-level metrics of communications between the UE 104 and the network entity 102. At a second communication 608, the UE 104 may transmit the configured uplink communication to the network entity 102.

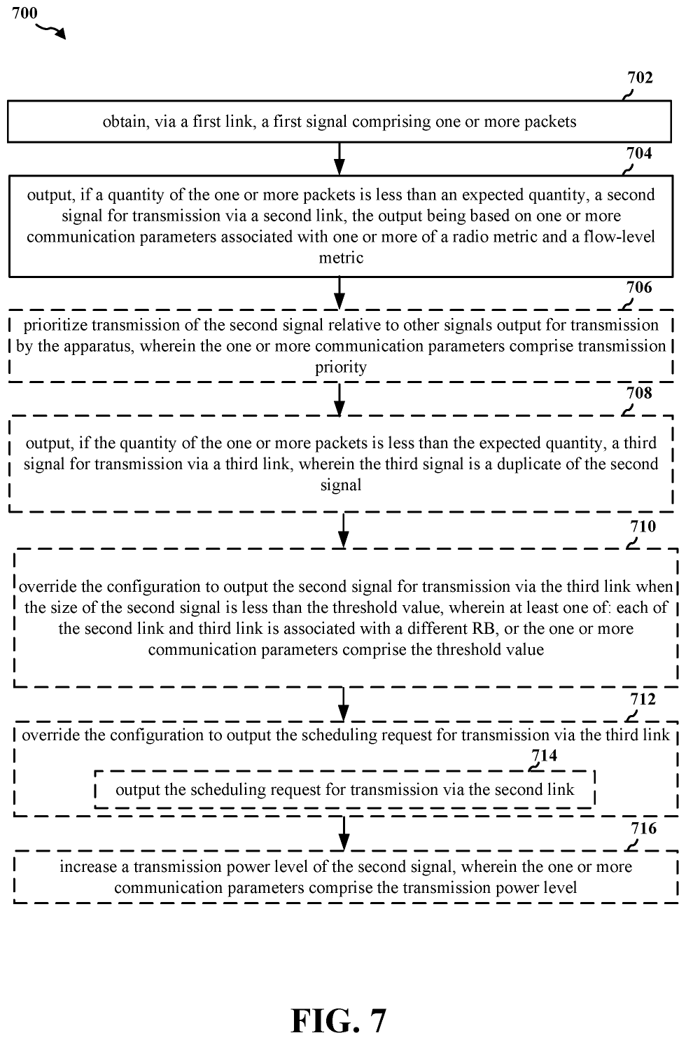

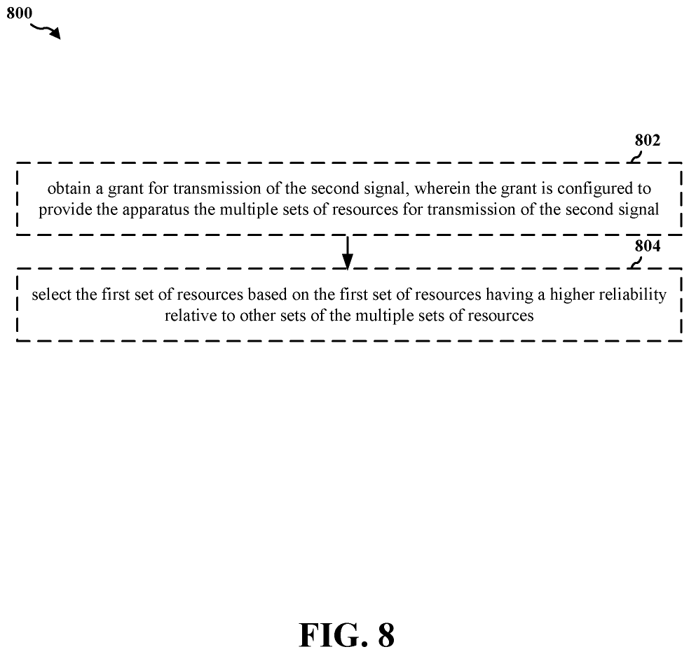

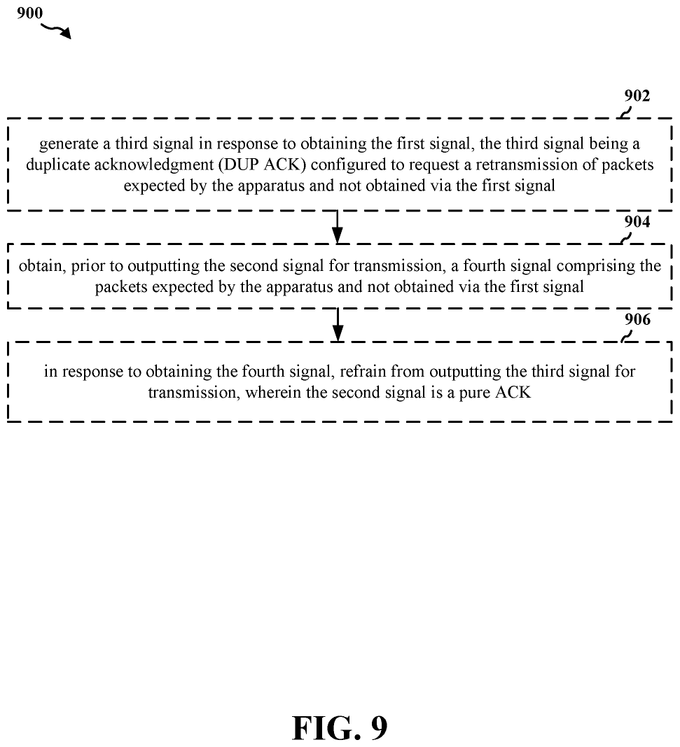

FIG. 7 is a flowchart 700 of a method of wireless communication. The method may be performed by a UE (e.g., the UE 104; the apparatus 1002). The UE may perform one or more of the blocks illustrated in FIG. 7 with conjunction with one or more blocks of any of FIGS. 8 and 9. At 702, the UE may obtain, via a first link, a first signal comprising one or more packets. For example, 702 may be performed by an obtaining component 1040. For example, the first signal may be a downlink transmission transmitted via a first link, wherein the downlink transmission includes one or more packets of data for the UE 104. However, the UE 104 may expect the downlink transmission to include additional packets. That is, the downlink transmission may be missing packets as it is received at the UE 104. In some examples, the downlink transmission may be an OOOD. Such a communication is illustrated in a first communication 602 of FIG. 6.

At 704, the UE may output, if a quantity of the one or more packets is less than an expected quantity, a second signal for transmission via a second link, the output being based on one or more communication parameters associated with one or more of a radio metric and a flow-level metric. For example, 704 may be performed by an outputting component 1042. Here, the UE 104 may configure an uplink transmission according to one or more uplink communication parameters based on OOOD downlink and/or one or more radio metrics and/or flow-level metrics of communications between the UE 104 and a network entity. An example of this communication is illustrated as the second communication 608 of FIG. 6.

At 706, the UE may prioritize transmission of the second signal relative to other signals output for transmission by the UE, wherein the one or more communication parameters comprise transmission priority. For example, 706 may be performed by a priority component 1044. Here, if a particular downlink is affected by OOOD, or one or more radio metrics and/or flow-level metrics may reduce the quality of communications between the UE 104 and the network entity. In response, the UE 104 may configure a corresponding uplink transmission such that it is prioritized. In other words, the UE 104 may use the one or more radio metrics and/or flow-level metrics as an input to determining how to transmit an uplink communication. In some examples, the UE 104 may compensate for latency issues caused by downlink OOOD by prioritizing uplink transmissions. By quickly transmitting uplink data and or control information (e.g., uplink control information (UCI)), the UE 104 can cause an application-level retransmission by the network entity faster than if the uplink is not prioritized.

At 708, the UE may output, if the quantity of the one or more packets is less than the expected quantity, a third signal for transmission via a third link, wherein the third signal is a duplicate of the second signal. For example, 708 may be performed by the outputting component 1042. Here, a flow-level metric may be indicative of at least one of a QoS requirement of at the first link and/or the second link, a codec degradation of the UE as a result of the one or more packets being less than the number of packets the UE expects, and/or a type of grant provided to the UE via the network node. For example, a flow-level metric may be indicative of a QoS requirement that is not being met for a downlink or uplink communication. In such a case, the UE 104 may determine to duplicate transmission of uplink communications made in response to OOOD downlink flows.

At 710, the UE may override the configuration to output the second signal for transmission via the third link when the size of the second signal is less than the threshold value, wherein at least one of: each of the second link and third link is associated with a different RB, or the one or more communication parameters comprise the threshold value. For example, 708 may be performed by an override component 1046. Here, in one example, the UE 104 may be configured with a threshold value (e.g., ul-DataSplitThreshold) indicating a size of data for an uplink data split operation. The threshold value may indicate which RLC (e.g., LTE RLC or NR RLC) to use for uplink transmission based on a size of data being transmitted. For example, if the uplink data is less than 1 k bytes, the threshold value may cause the UE 104 to send the data on LTE only. However, in some examples, the UE 104 may override this threshold value if it determines that another RLC is a faster and/or more reliable RLC for transmitting an uplink communication. Thus, the override component 1046 may override the UE configuration to: output, if a size of the second signal is less than a threshold value for a radio bearer (RB) split communication, the second signal for transmission via a third link, and output, if a size of the second signal is greater than the threshold value, the second signal for transmission via the second link.

At 712, the UE may override the configuration to output the scheduling request for transmission via the third link, and at 714, the UE may output the scheduling request for transmission via the second link. For example, 712 may be performed by the override component 1046. Here, the UE 104 may override the threshold value configuration to transmit the uplink scheduling communication via a different RLC or more than one RLCs.

At 716, the UE may increase a transmission power level of the second signal, wherein the one or more communication parameters comprise the transmission power level. For example, 712 may be performed by a power component 1048. Here, the UE 104 may increase the transmit power of an uplink transmission made in response to a corresponding OOOD downlink communication. For example, the UE 104 may transmit an uplink communication with higher power to ensure the network entity reliably receives the uplink communication. Thus, in this example, the communication parameter may include a transmit power for uplink communications, and the transmit power may be adjusted based on a corresponding OOOD downlink communication, and/or any of one or more radio metrics and/or flow-level metrics of a communication with the network entity.

FIG. 8 is a flowchart 800 of a method of wireless communication. The method may be performed by a UE (e.g., the UE 104; the apparatus 1002). The UE may perform one or more of the blocks illustrated in FIG. 8 with conjunction with one or more blocks of any of FIGS. 7 and 9. At 802, the UE may obtain a grant for transmission of the second signal, wherein the grant is configured to provide the UE the multiple sets of resources for transmission of the second signal. For example, 702 may be performed by the obtaining component 1040. Here, the UE 104 may receive a single DCI configured to provide the UE 104 with a grant for multiple sets of uplink resources (e.g., multiple PUSCH occasions and/or component carriers). In some examples, and in response to OOOD downlink and/or any of one or more radio metrics and/or flow-level metrics, the UE 104 may determine which set of the multiple sets of uplink resources has a higher reliability and/or MCS for uplink transmission. In such an example, the UE 104 may delay an uplink transmission (e.g., if a less reliable set of uplink resources occurs before a more reliable set) to transmit via an optimal set of resources. Thus, the UE 104 may prefer to transmit an uplink communication via a relatively more reliable set of uplink resources over a less reliable set that occurs first in time.

At 804, the UE may select the first set of resources based on the first set of resources having a higher reliability relative to other sets of the multiple sets of resources. For example, 804 may be performed by a selecting component 1050. Here, the UE 104 may select a particular radio resource to use for transmitting an uplink communication made in response to an OOOD downlink flow. Here, the UE 104 may determine that the particular radio resource is an optimal resource based on latency, reliability, MCS, BLER, and/or any other suitable radio resource characteristics. For example, if the UE 104 can transmit an uplink communication via either of an LTE RLC or an NR RLC, but the NR RLC is more reliable and is faster relative to LTE RLC, then the UE 104 may select the NR RLC for transmitting the uplink communication even if resources of the LTE RLC are granted. In another example, the UE 104 may select a particular component carrier (e.g., CC0) of the NR RLC based on CC0 having a lower BLER than another component carrier (e.g., CC1) of the NR RLC. Thus, the communication parameter may include an optimal radio resource selected by the UE 104 in response to a corresponding OOOD downlink communication.

FIG. 9 is a flowchart 900 of a method of wireless communication. The method may be performed by a UE (e.g., the UE 104; the apparatus 1002). The UE may perform one or more of the blocks illustrated in FIG. 9 with conjunction with one or more blocks of any of FIGS. 8 and 9. At 902, the UE may generate a third signal in response to obtaining the first signal, the third signal being a duplicate acknowledgment (DUP ACK) configured to request a retransmission of packets expected by the UE and not obtained via the first signal. For example, 902 may be performed by a generating component 1052. Here, in one example, when OOOD is used on a downlink, the UE 104 will receive packets out of sequence and may generate frequent DUP ACKs. In some cases, the UE 104 may stop generating DUP ACKs when the UE 104 receives the missing packets it expected from a previous downlink. However, if the UE 104 is frequently generating and transmitting DUP ACKs because of OOOD downlink, TCP downlink throughput may be negatively affected. Accordingly, in some examples, the UE 104 may determine to delay an uplink DUP ACK transmission. For example, the UE 104 may receive an OOOD downlink having less than all expected packets. In response, the UE 104 may generate a DUP ACK requesting retransmission of the missing packets, but instead of immediately transmitting the DUP ACK, the UE 104 may delay its transmission for a preconfigured (e.g., the network entity 102 may configure the amount of time that the UE 104 may delay) or defined amount of time.

At 904, the UE may obtain, prior to outputting the second signal for transmission, a fourth signal comprising the packets expected by the apparatus and not obtained via the first signal. For example, 902 may be performed by the obtaining component 1040. Here, if the UE 104 did not receive all of the expected packets, a delay may provide the network entity with enough time to correct the problem and transmit the missing packets to the UE 104 before the UE 104 sends the DUP ACK. Thus, if the missing packets are received by the UE 104 before expiration of the delay, the UE 104 may internally delete the DUP ACK so that it is not transmitted. This avoids signaling a TCP loss to the network entity 102 if such signaling is not necessary. If the missing packets are not received by the time the delay expires, the UE 104 may proceed to transmit the DUP ACK to the network entity 102 to trigger the needed TCP retransmission. Here, the UE may instead transmit a pure ACK (e.g., an ACK acknowledging all expected packets received).

At 906, the UE may, in response to obtaining the fourth signal, refrain from outputting the third signal for transmission, wherein the second signal is a pure ACK. For example, 902 may be performed by a refraining component 1054.

In certain aspects, at least one of: the first signal is obtained from a network entity, or the radio metric comprises one or more of a scheduling rate associated with the network entity and a buffering latency associated with the network entity.

In certain aspects, at least one of: the second signal is a duplicate acknowledgment (DUP ACK) configured to request a retransmission of packets expected by the UE and not received, or the radio metric comprises a previous retransmission speed of packets expected by the UE and not received.

In certain aspects, at least one of: the first signal is obtained from a network entity, or the radio metric comprises one or more of a location of the UE relative to the network entity, a signal condition of at least one of the first link or the second link, and a data rate associated with at least one of the first link or the second link.

In certain aspects, at least one of: the first signal is obtained from a network entity, or the flow-level metric comprises an indication of whether the network entity uses an error correction capability for transmission of packets to the UE.

In certain aspects, at least one of: the first signal is obtained from a network entity, or the flow-level metric comprises a type of communication protocol used by the network entity for transmission of the first signal.

In certain aspects, the flow-level metric comprises at least one of a quality of service (QoS) requirement of at least one of the first link or the second link, a codec degradation of the UE as a result of the one or more packets being less than the expected quantity, or a type of grant provided to the UE via a network entity.

In certain aspects, the one or more communication parameters comprise transmission duplication.

In certain aspects, the one or more communication parameters comprise one or more of a latency of the second link, a reliability of the second link, a modulation and coding scheme (MCS) of the second link, and a block error rate of the second link.

In certain aspects, the apparatus is configured to output, if a size of the second signal is less than a threshold value for a radio bearer (RB) split communication, the second signal for transmission via a third link; and output, if a size of the second signal is greater than the threshold value, the second signal for transmission via the second link. In some examples, the apparatus is also configured to override the configuration to output the second signal for transmission via the third link when the size of the second signal is less than the threshold value, wherein at least one of: each of the second link and third link is associated with a different RB, or the one or more communication parameters comprise the threshold value.

In certain aspects, the second signal is output for transmission via a first set of resources of multiple sets of resources.

In certain aspects, the first signal is an out-of-order delivery (OOOD) of the one or more packets.

In certain aspects, the first link is an uplink path, and wherein the second link is a downlink path.

In certain aspects, at least one of: the first signal is obtained from a network entity, or the radio metric comprises one or more of a location of the apparatus relative to the network entity, a signal condition of at least one of the first link or the second link, and a data rate associated with at least one of the first link or the second link.

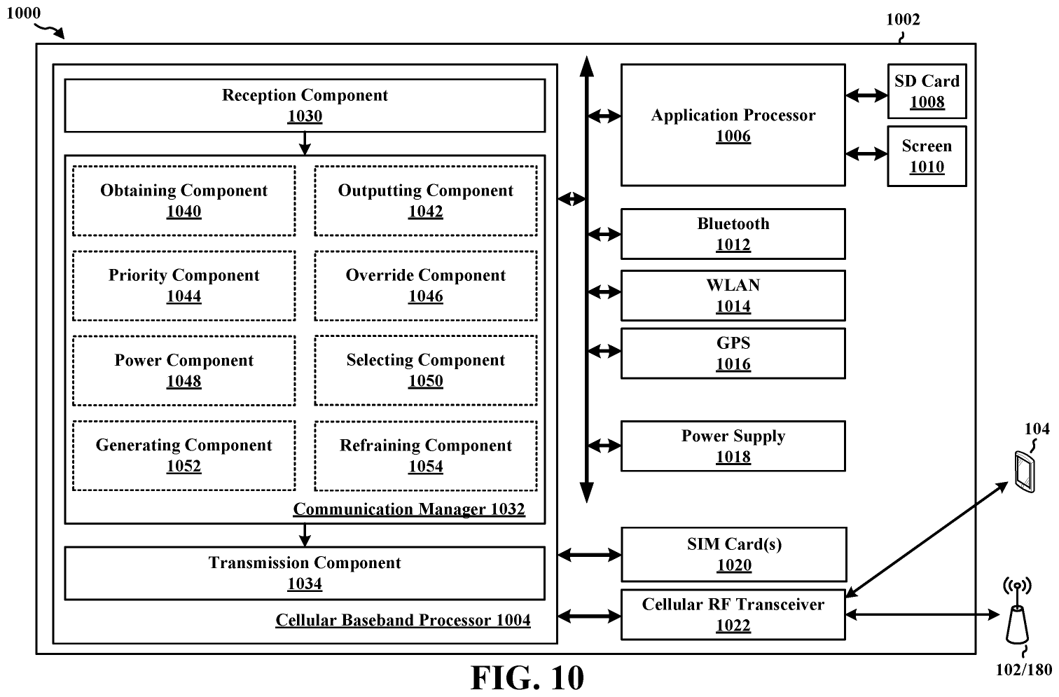

FIG. 10 is a diagram 1000 illustrating an example of a hardware implementation for an apparatus 1002. The apparatus 1002 is a UE and includes a cellular baseband processor 1004 (also referred to as a modem) coupled to a cellular RF transceiver 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The cellular baseband processor 1004 communicates through the cellular RF transceiver 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 104 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see 104 of FIG. 3) and include the aforediscussed additional modules of the apparatus 1002. In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes an obtaining component 1040 that is configured to obtain, via a first link, a first signal comprising one or more packets; obtain a grant for transmission of the second signal, wherein the grant is configured to provide the apparatus the multiple sets of resources for transmission of the second signal; and obtain, prior to outputting the second signal for transmission, a fourth signal comprising the packets expected by the apparatus and not obtained via the first signal; e.g., as described in connection with 702, 802, and 904.

The communication manager 1032 further includes an outputting component 1042 configured to output, if a quantity of the one or more packets is less than an expected quantity, a second signal for transmission via a second link, the output being based on one or more communication parameters associated with one or more of a radio metric and a flow-level metric; output, if the quantity of the one or more packets is less than the expected quantity, a third signal for transmission via a third link, wherein the third signal is a duplicate of the second signal; and output the scheduling request for transmission via the second link; e.g., as described in connection with 704, 708, and 714.

The communication manager 1032 further includes a priority component 1044 configured to prioritize transmission of the second signal relative to other signals output for transmission by the apparatus, wherein the one or more communication parameters comprise transmission priority, e.g., as described in connection with 706.

The communication manager 1032 further includes an override component 1046 configured to override the configuration to output the second signal for transmission via the third link when the size of the second signal is less than the threshold value, wherein at least one of: each of the second link and third link is associated with a different RB, or the one or more communication parameters comprise the threshold value; and override the configuration to output the scheduling request for transmission via the third link; e.g., as described in connection with 710 and 712.

The communication manager 1032 further includes a power component 1048 configured to increase a transmission power level of the second signal, wherein the one or more communication parameters comprise the transmission power level, e.g., as described in connection with 716.

The communication manager 1032 further includes a selecting component 1050 configured to select the first set of resources based on the first set of resources having a higher reliability relative to other sets of the multiple sets of resources, e.g., as described in connection with 804.

The communication manager 1032 further includes a generating component 1052 configured to generate a third signal in response to obtaining the first signal, the third signal being a duplicate acknowledgment (DUP ACK) configured to request a retransmission of packets expected by the apparatus and not obtained via the first signal, e.g., as described in connection with 902.

The communication manager 1032 further includes a refraining component 1054 configured to, in response to obtaining the fourth signal, in response to obtaining the fourth signal, refrain from outputting the third signal for transmission, wherein the second signal is a pure ACK, e.g., as described in connection with 906.

The apparatus may include additional components that perform each of the blocks of the algorithm in the aforementioned flowcharts of FIGS. 7-9. As such, each block in the aforementioned flowcharts may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the cellular baseband processor 1004, includes: means for obtaining, via a first link, a first signal comprising one or more packets; means for outputting, if a quantity of the one or more packets is less than an expected quantity, a second signal for transmission via a second link, the output being based on one or more communication parameters associated with one or more of a radio metric and a flow-level metric; means for prioritizing transmission of the second signal relative to other signals output for transmission by the apparatus, wherein the one or more communication parameters comprise transmission priority; means for outputting, if the quantity of the one or more packets is less than the expected quantity, a third signal for transmission via a third link, wherein the third signal is a duplicate of the second signal; means for overriding the configuration to output the second signal for transmission via the third link when the size of the second signal is less than the threshold value, wherein at least one of: each of the second link and third link is associated with a different RB, or the one or more communication parameters comprise the threshold value; means for overriding the configuration to output the scheduling request for transmission via the third link; means for output the scheduling request for transmission via the second link; means for increasing a transmission power level of the second signal, wherein the one or more communication parameters comprise the transmission power level; means for obtaining a grant for transmission of the second signal, wherein the grant is configured to provide the apparatus the multiple sets of resources for transmission of the second signal; means for selecting the first set of resources based on the first set of resources having a higher reliability relative to other sets of the multiple sets of resources; means for generating a third signal in response to obtaining the first signal, the third signal being a duplicate acknowledgment (DUP ACK) configured to request a retransmission of packets expected by the apparatus and not obtained via the first signal; means for obtaining, prior to outputting the second signal for transmission, a fourth signal comprising the packets expected by the apparatus and not obtained via the first signal; and means for, in response to obtaining the fourth signal, refrain from outputting the third signal for transmission, wherein the second signal is a pure ACK.

The aforementioned means may be one or more of the aforementioned components of the apparatus 1002 configured to perform the functions recited by the aforementioned means. As described supra, the apparatus 1002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include receive processor 356 and/or antenna(s) 352 of the UE 104 illustrated in FIG. 3. Means for transmitting or means for outputting may include the transmit processor 368 or antenna(s) 352 of the UE 104 illustrated in FIG. 3. Means for prioritizing, means for overriding, means for increasing transmit power, means for selecting, means for refraining, and means for generating may include a processing system, which may include one or more processors, such as the controller/processor 359, the memory 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Additional Considerations

As used herein, the terms “selecting” and/or “determining” (or any variants thereof such as “select” and determine”) encompass a wide variety of actions. For example, “selecting” and/or “determining” may include calculating, computing, processing, deriving, investigating, looking up (e.g., looking up in a table, a database or another data structure), ascertaining and the like.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, Conly, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Example 1 is a method for wireless communication at an apparatus, comprising: obtaining, via a first link, a first signal comprising one or more packets; and outputting, if a quantity of the one or more packets is less than an expected quantity, a second signal for transmission via a second link, the output being based on one or more communication parameters associated with one or more of a radio metric and a flow-level metric.

Example 2 is the method of example 1, wherein at least one of: the first signal is obtained from a network entity, or the radio metric comprises one or more of a scheduling rate associated with the network entity and a buffering latency associated with the network entity.

Example 3 is the method of any of examples 1 and 2, wherein at least one of: the second signal is a duplicate acknowledgment (DUP ACK) configured to request a retransmission of packets expected by the apparatus and not received, or the radio metric comprises a previous retransmission speed of packets expected by the apparatus and not received.

Example 4 is the method of any of examples 1-3, wherein at least one of: the first signal is obtained from a network entity, or the radio metric comprises one or more of a location of the apparatus relative to the network entity, a signal condition of at least one of the first link or the second link, and a data rate associated with at least one of the first link or the second link.

Example 5 is the method of any of examples 1-4, wherein at least one of: the first signal is obtained from a network entity, or the flow-level metric comprises an indication of whether the network entity uses an error correction capability for transmission of packets to the apparatus.

Example 6 is the method of any of examples 1-5, at least one of: the first signal is obtained from a network entity, or the flow-level metric comprises a type of communication protocol used by the network entity for transmission of the first signal.

Example 7 is the method of any of examples 1-6, wherein the flow-level metric comprises at least one of a quality of service (QOS) requirement of at least one of the first link or the second link, a codec degradation of the apparatus as a result of the one or more packets being less than the expected quantity, or a type of grant provided to the apparatus via a network entity.

Example 8 is the method of any of examples 1-7, wherein the method further comprises: prioritizing transmission of the second signal relative to other signals output for transmission by the apparatus, wherein the one or more communication parameters comprise transmission priority.

Example 9 is the method of example 1-8, wherein the method further comprises: outputting, if the quantity of the one or more packets is less than the expected quantity, a third signal for transmission via a third link, wherein the third signal is a duplicate of the second signal.

Example 10 is the method of example 9, wherein the one or more communication parameters comprise transmission duplication.

Example 11 is the method of any of examples 1-10, wherein the one or more communication parameters comprise one or more of a latency of the second link, a reliability of the second link, a modulation and coding scheme (MCS) of the second link, and a block error rate of the second link.

Example 12 is the method of any of examples 1-11, wherein the apparatus is configured for outputting, if a size of the second signal is less than a threshold value for a radio bearer (RB) split communication, the second signal for transmission via a third link; and outputting, if a size of the second signal is greater than the threshold value, the second signal for transmission via the second link, wherein the method further comprises: overriding the configuration to output the second signal for transmission via the third link when the size of the second signal is less than the threshold value, wherein at least one of: each of the second link and third link is associated with a different RB, or the one or more communication parameters comprise the threshold value.

Example 13 is the method of example 12, wherein the method further comprises: outputting, if a size of a scheduling request is less than the threshold value for the RB split communication, the scheduling request for transmission via the third link; overriding the configuration to output the scheduling request for transmission via the third link; and outputting the scheduling request for transmission via the second link.

Example 14 is the method of any of examples 1-13, wherein the method further comprises: increasing a transmission power level of the second signal, wherein the one or more communication parameters comprise the transmission power level.

Example 15 is the method of any of examples 1-14, wherein the second signal is output for transmission via a first set of resources of multiple sets of resources based on the first set of resources having a higher reliability relative to other sets of the multiple sets of resources, wherein the method further comprises: obtaining a grant for transmission of the second signal, wherein the grant is configured to provide the apparatus the multiple sets of resources.

Example 16 is the method of any of examples 1-15, wherein the method further comprises: generating a third signal in response to obtaining the first signal, the third signal being a duplicate acknowledgment (DUP ACK) configured to request a retransmission of packets expected by the apparatus and not obtained via the first signal; obtaining, prior to outputting the second signal for transmission, a fourth signal comprising the packets expected by the apparatus and not obtained via the first signal; and in response to obtaining the fourth signal, refrain from outputting the third signal for transmission, wherein the second signal is a pure ACK.

Example 17 is the method of any of examples 1-16, wherein the first signal is an out-of-order delivery (OOOD) of the one or more packets.

Example 18 is the method of any of examples 1-17, wherein the first link is an uplink path, and wherein the second link is a downlink path.

Example 19 is a UE, comprising: a transceiver; a memory comprising instructions; and one or more processors configured to execute the instructions to cause the UE to perform a method in accordance with any one of examples 1-18, wherein the transceiver is configured to: receive the first signal; and transmit the second signal via the second link.

Example 20 is an apparatus for wireless communications, comprising means for performing a method in accordance with any one of examples 1-18.

Example 21 is a non-transitory computer-readable medium comprising instructions that, when executed by an apparatus, cause the apparatus to perform a method in accordance with any one of examples 1-18.

Example 22 is an apparatus for wireless communications, comprising: a memory comprising instructions; and one or more processors configured to execute the instructions to cause the apparatus to perform a method in accordance with any one of examples 1-18.

What is claimed is:

1. An apparatus configured for wireless communication, comprising:
a memory comprising instructions; and
one or more processors configured to execute the instructions and cause the apparatus to:
obtain, via a first link, a first signal comprising one or more packets; and
output, if a quantity of the one or more packets is less than an expected quantity, a second signal for transmission via a second link, the output being based on one or more communication parameters associated with one or more of a radio metric and a flow-level metric.

2. The apparatus of claim 1, wherein at least one of:
the first signal is obtained from a network entity, or
the radio metric comprises one or more of a scheduling rate associated with the network entity and a buffering latency associated with the network entity.

3. The apparatus of claim 1, wherein at least one of:
the second signal is a duplicate acknowledgment (DUP ACK) configured to request a retransmission of packets expected by the apparatus and not received, or
the radio metric comprises a previous retransmission speed of packets expected by the apparatus and not received.

4. The apparatus of claim 1, wherein at least one of:
the first signal is obtained from a network entity, or
the radio metric comprises one or more of a location of the apparatus relative to the network entity, a signal condition of at least one of the first link or the second link, and a data rate associated with at least one of the first link or the second link.

5. The apparatus of claim 1, wherein at least one of:
the first signal is obtained from a network entity, or
the flow-level metric comprises an indication of whether the network entity uses an error correction capability for transmission of packets to the apparatus.

6. The apparatus of claim 1, wherein at least one of:
the first signal is obtained from a network entity, or
the flow-level metric comprises a type of communication protocol used by the network entity for transmission of the first signal.

7. The apparatus of claim 1, wherein the flow-level metric comprises at least one of a quality of service (QOS) requirement of at least one of the first link or the second link, a codec degradation of the apparatus as a result of the one or more packets being less than the expected quantity, or a type of grant provided to the apparatus via a network entity.

8. The apparatus of claim 1, wherein the one or more processors are further configured to cause the apparatus to:
prioritize transmission of the second signal relative to other signals output for transmission by the apparatus, wherein the one or more communication parameters comprise transmission priority.

9. The apparatus of claim 1, wherein the one or more processors are further configured to cause the apparatus to:
output, if the quantity of the one or more packets is less than the expected quantity, a third signal for transmission via a third link, wherein the third signal is a duplicate of the second signal.

10. The apparatus of claim 9, wherein the one or more communication parameters comprise transmission duplication.

11. The apparatus of claim 1, wherein the one or more communication parameters comprise one or more of a latency of the second link, a reliability of the second link, a modulation and coding scheme (MCS) of the second link, and a block error rate of the second link.

12. The apparatus of claim 1, wherein the apparatus is configured to:
output, if a size of the second signal is less than a threshold value for a radio bearer (RB) split communication, the second signal for transmission via a third link; and
output, if a size of the second signal is greater than the threshold value, the second signal for transmission via the second link, wherein the one or more processors are further configured to cause the apparatus to:
override the configuration to output the second signal for transmission via the third link when the size of the second signal is less than the threshold value, wherein at least one of:
each of the second link and third link is associated with a different RB, or
the one or more communication parameters comprise the threshold value.

13. The apparatus of claim 12, wherein the apparatus is configured to output, if a size of a scheduling request is less than the threshold value for the RB split communication, the scheduling request for transmission via the third link, and wherein the one or more processors are further configured to cause the apparatus to:
override the configuration to output the scheduling request for transmission via the third link; and
output the scheduling request for transmission via the second link.

14. The apparatus of claim 1, wherein the one or more processors are further configured to cause the apparatus to:
increase a transmission power level of the second signal, wherein the one or more communication parameters comprise the transmission power level.

15. The apparatus of claim 1, wherein the second signal is output for transmission via a first set of resources of multiple sets of resources based on the first set of resources having a higher reliability relative to other sets of the multiple sets of resources, wherein the one or more processors are further configured to cause the apparatus to:
obtain a grant for transmission of the second signal, wherein the grant is configured to provide the apparatus the multiple sets of resources.

16. The apparatus of claim 1, wherein the one or more processors are further configured to cause the apparatus to:
generate a third signal in response to obtaining the first signal, the third signal being a duplicate acknowledgment (DUP ACK) configured to request a retransmission of packets expected by the apparatus and not obtained via the first signal;
obtain, prior to outputting the second signal for transmission, a fourth signal comprising the packets expected by the apparatus and not obtained via the first signal; and
in response to obtaining the fourth signal, refrain from outputting the third signal for transmission, wherein the second signal is a pure ACK.

17. The apparatus of claim 1, wherein the first signal is an out-of-order delivery (OOOD) of the one or more packets.

18. The apparatus of claim 1, wherein the first link is an uplink path, and wherein the second link is a downlink path.

19. A user equipment (UE), comprising:
a transceiver;
a memory comprising instructions; and
one or more processors configured to execute the instructions and cause the UE to:
receive, via the transceiver and a first link, a first signal comprising one or more packets; and
transmit, if a quantity of the one or more packets is less than an expected quantity, a second signal via the transceiver and a second link, the transmission being based on one or more communication parameters associated with one or more of a radio metric and a flow-level metric.

20. A method for wireless communications at a wireless node, comprising:
obtaining, via a first link, a first signal comprising one or more packets; and
outputting, if a quantity of the one or more packets is less than an expected quantity, a second signal for transmission via a second link, the output being based on one or more communication parameters associated with one or more of a radio metric and a flow-level metric.
